(19) United States
(12) Patent Application Publication
(10) Pub. No.: US 2018/0269726 A1
(43) Pub. Date: Sep. 20, 2018

(54) Inductive Power Transmitter

(71) Applicant: Apple Inc., Cupertino, CA (US)

(72) Inventor: Ali Abdolkhani, Auckland (NZ)

(21) Appl. No.: 15/920,137

(22) Filed: Mar. 13, 2018

Related U.S. Application Data
(60) Provisional application No. 62/471,566, filed on Mar. 15, 2017.

(51) Int. Cl. H02J 50/12

(52) U.S. Cl. CPC H02J 50/12; H02M 7/53871

(57) ABSTRACT

An inductive power transmitter comprising an power transfer circuit which includes a transmitter coil; and a power inverter including a plurality of control devices configured to drive the power transfer circuit; a controller configured to provide drive signals for the control devices, wherein the controller is programmed to estimate the power in the power transfer circuit; compare the estimated power to a predetermined power level; and calculate an adjustment to the drive signals based on the comparison, to adjust the power in the power transfer circuit to the predetermined power level.

### FIELD

This invention relates generally to a converter, particularly though not solely, to a converter for an inductive power transmitter.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’ or for power transfer in an industrial or commercial environment, such as in wind turbines).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver.

### SUMMARY

The present invention may provide an improved inductive power transmitter or which provides the public with a useful choice.

According to a first aspect there is provided an inductive power transmitter according to claim 1.

Embodiments may be provided according to any of the dependant claims.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a circuit diagram of an example transmitter;

FIG. 3 is a simplified circuit diagram of an example transmitter; and

FIG. 4 is a flow diagram of a control strategy.

### DETAILED DESCRIPTION

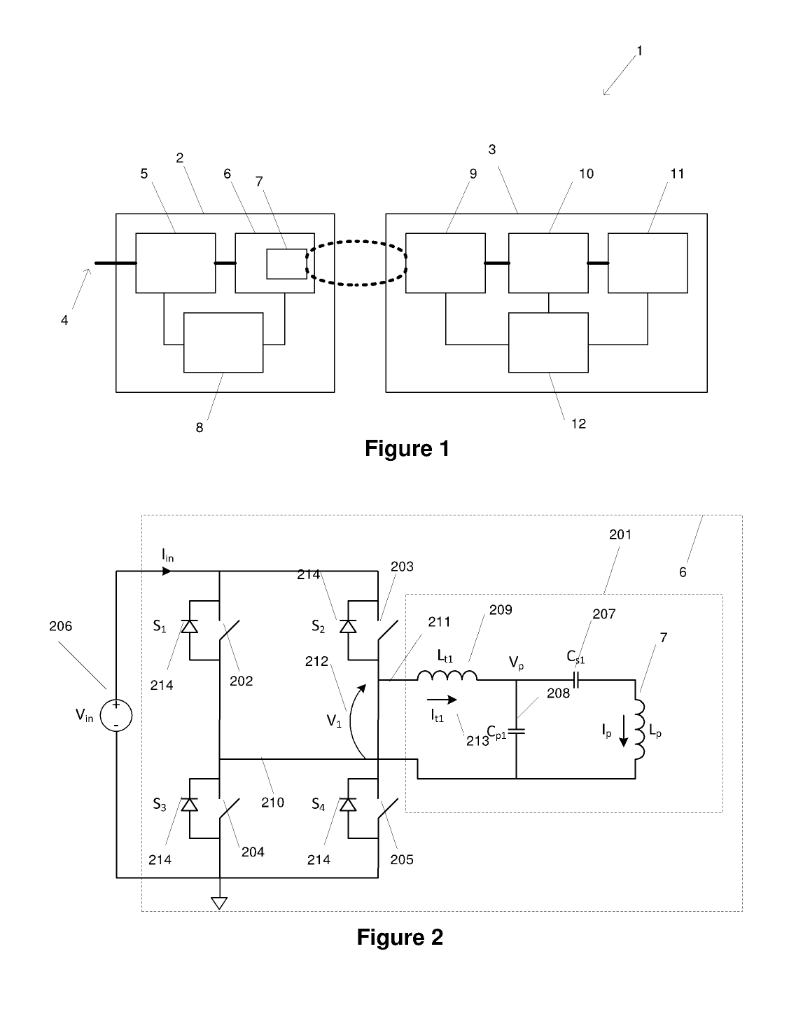

An IPT system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit. Additional coils may be provided, for example in an LCL configuration.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications.

The inductive power receiver 3 includes a power pick up stage 9 connected to power conditioning circuitry 10 that in turn supplies power to a load 11. The power pick up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors (not shown) either in parallel or series to create a resonant circuit. Additional coils may be provided, for example in an LCL configuration.

In some inductive power receivers, the receiver may include a controller 12 which may control tuning of the receiving coil or coils, operation of the power conditioning circuitry 10 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

Various different topologies for inductive power transfer (IPT) are used depending on the application. For example the inductive power transmitter 2 and/or the inductive power receiver 3 may be resonant or non-resonant. Resonant power transfer has the advantage that the range of power transfer can be increased, compared to non-resonant transfer.

Resonant topologies may include series resonant circuits or parallel resonant circuits. Another topology is LCL, which is a combination of both series and parallel tuning that uses at least two inductors and at least one capacitor. Each option has pros and cons.

From the point of view of the inverter 6, a series tuned transmitting coil or coils 7 can appear as a low impedance load at its tuned frequency and a high impedance load at higher frequencies due to the series inductive element. Because of this the series tuned transmitting coil or coils 7 can draw significant current from the inverter 6 when being driven at the resonant frequency, even when a low inverter 6 output voltage is used. A consequence of this is that, when driven at a fixed voltage, for example from a voltage source inverter 6 such as a full bridge inverter, a series tuned transmitting coil or coils 7 can build up a large and uncontrolled resonant voltage and current, which risks damaging the inverter 6 and the inductive power receiver 3. Furthermore, all of the current which flows in the transmitting coil or coils 7 also flows through the inverter 6, which can lead to lower efficiency of the inductive power transmitter 2.

On the other hand from the point of view of the inverter 6, a parallel tuned transmitting coil or coils 7 can appear as a high impedance load at its tuned frequency and a low impedance load at higher frequencies due to the parallel capacitive element. This is inherently not well suited for use with voltage source inverters 6 such as a full bridge inverter, because the voltage source inverter will typically try to force its output voltage to rapidly switch from one value to another. This rapidly changing voltage in parallel with the parallel tuning capacitor of the transmitting coil or coils 7 can result in large transient currents which can damage the inverter 6.

An LCL tuned transmitting coil or coils 7 has a combination of the input and output characteristics of the parallel and series tuned transmitting coil or coils 7. For example, with an LCL tuned transmitting coil or coils 7 when an inductive power receiver 3 is not present, the inductive power transmitter 2 can maintain a current flowing in the transmitting coil or coils 7 without needing to switch high currents through the switches of the inverter 6, even when the inverter 6 is a voltage source inverter. An LCL tuned transmitting coil or coils 7 may allow power transfer at unity power factor when driven with a voltage source inverter. That is the real power flowing into the LCL tuned transmitting coil or coils 7 network from the inverter 6 can be substantially equal to the apparent power.

FIG. 2 shows an example of an inverter 6 which uses LCL tuned circuit 201. The inverter includes switches S1 202, S2 203, S3 204 and S4 205. A DC source 206 is shown here for simplicity but would in practice be provided by the converter 5 or from a power supply 4. A transmitting coil or coils 7 is connected first in series with a series tuning capacitor 207, the combination of which is then connected in parallel with a parallel tuning capacitor 208. This is then connected to a series tuning inductor 209 which is in turn connected to switches S2 203 and S4 205 of the inverter 6. Switches S1 202 and S3 204 drive the first leg 210 of the LCL tuned circuit 201 and switches S2 203 and S4 205 drive the second leg 211. The driving voltage 212 to the LCL tuned circuit 201 is the voltage difference between the first leg 210 and the second leg 211. The current flowing into the LCL tuned circuit 201 flows through the series tuning inductor 209 and is denoted the driving current 213. The body diodes 214 of the switches S1 202, S2 203, S3 204 and S4 205 are explicitly shown however in practice these will typically be a part of the switches, which will typically be MOSFETs. However, it is also possible to use other device types such as but not limited to bipolar junction transistors, silicon carbide FETs, gallium nitride FETs or IGBTs.

An LCL tuned circuit 201 should comprise a transmitting coil or coils 7, a parallel tuning capacitor 208 and a series tuning inductor 209. The values of the components should be chosen for a resonant frequency. This tuned frequency may for example be the designated IPT frequency, or frequency range, or it may be shifted from that depending on the application requirements. In order for the LCL circuit to be tuned at the resonant frequency, the reactance of each branch should be matched. For example the series tuning inductor 209 is the same reactance as parallel tuning capacitor 208 which must be the same reactance as the combination of transmitting coil 7 and the series tuning capacitor 207. It is also possible to split one or more of the reactive components to create a more symmetrical circuit, for example, splitting the series tuning inductor 209 into two tuning inductors each of half the inductance value, one connected to S1 202 and S3 204 and the other in the present position of the series tuning inductor 209. Further another capacitor could be placed in series with series tuning inductor 209 and/or the tuning of the LCL circuit may be detuned, depending on the application requirements.

It is advantageous to use a full bridge inverter or a half bridge inverter to drive an LCL tuned circuit 201, because it allows for an inductive power transmitter 2 that is as simple as possible and has a lower component count. If DC power is fed directly into the inductive power transmitter 2, a separate converter 5 may not be required because the effective duty cycle of the inverter 6 can be changed in order to control the amplitude of the current flowing in the transmitting coil or coils 7. In this way, high efficiency of the IPT system 1 can be achieved, irrespective of input voltage or changes in the coupling coefficient between the inductive power transmitter 2 and the inductive power receiver 3. In practice, efficiencies of better than 90% have been achieved even with 10% input voltage variation and with coupling coefficients that vary between 0.27 and 0.6 Furthermore, this full bridge inverter implementation of the inductive power transmitter 2 does not require a bulky DC inductor as is common in other DC converter 5 or inverter 6 designs. While a series tuning inductor 209 is still required, this is typically much smaller than a DC inductor would be.

Alternatively other transmitter configurations such as series tuned or parallel tuned may be used, and other inverter configurations such as push pull, depending on the requirements of the application.

In IPT applications with a large magnetic coupling variations, the system is normally designed and optimized for either the minimum or maximum coupling level depending on which one is the worst case scenario. If it is optimised for minimum coupling, the system will supply excessive unnecessary power when it is operating under maximum coupling. In typical consumer electronics IPT chargers, this can relate to a tenfold increase in power.

In high coupling situations control is needed to reduce the power from the transmitter to the required level. Traditional transmitter controllers are normally implemented by using a feedback from the receiver through a wireless communication channel. This is usually not desired as it may have the following problems:
Possible communication failure.
Due to the limited bandwidth of resonant circuits and delays in the wireless communication channel; transmitter controllers suffer from slow transient response as the output voltage cannot be regulated in sub-millisecond time intervals that are desirable.
Since the wireless communication system is operating very close to the IPT system, any switching noise from the high power electronics devices can easily cause interference.

According to an example embodiment transmitter power control may be implemented by coarsely controlling the power in the transmitter to a predetermined desired receiver power level. The desired level may be based on the rated full load of the receiver plus an estimate of losses. The desired level is compared an estimate of the current tank power to determine a change to the inverter control variable to achieve the desired level in 1 step.

This strategy is similar to feedforward control, because the change in control variable is based on a model of the inverter and is therefore able to be achieved in a single step rather than continuous or iterative feedback control. The solution only needs to be updated when the level of coupling changes, which can be determined from changes in the reflected impedance.

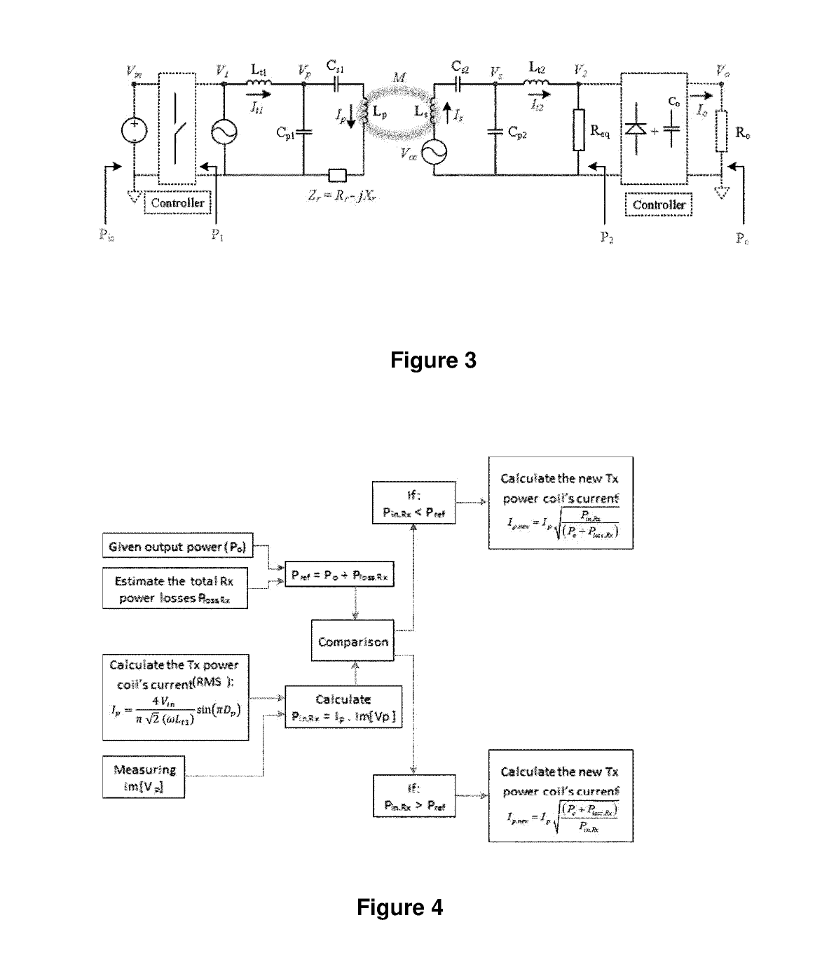

A simplified system model is shown in FIG. 3. Based on this model it is possible to reflect the receiver impedance into the transmitter circuit. The tank power can then be expressed in terms of the combined impedance and a measured value of the tank voltage. As shown in FIG. 4 the required receiver power is estimated and compared to the actual tank power. Based on this a new value of current is determined to achieve the required receiver power. As a result the receiver never receives more than it's rated level of power, which is then able to be more finely regulated at the receiver; eg: load voltage regulation to 5V. This is set out in detail below.

The governing equations of the model in FIG. 4 can be expressed as Equation (1) and (2):

$$\begin{matrix}{Z}_{L} = {R}_{eq} + j ω {L}_{t 2} & ( 1 ) \\ {Z}_{2} = {Z}_{L} ∥ ( \frac{1}{j ω {C}_{p 2}} ) = \frac{1}{{( ω {C}_{p 2} )}^{2} {R}_{eq}} - j \frac{1}{ω {C}_{p 2}} & ( 2 )\end{matrix}$$

And the total receiver impedance is shown in Equation (3):

$${Z}_{s} = {Z}_{2} + j ( ω {L}_{s} - \frac{1}{ω {C}_{s 2}} ) = \frac{1}{{( ω {C}_{p 2} )}^{2} {R}_{eq}} + j ( ω {L}_{s} - \frac{1}{ω {C}_{s 2}} - \frac{1}{ω {C}_{p2}} ) \qquad ( 3 )$$

Using (3), the total receiver network can be modelled as a reflected impedance back onto the transmitter as expressed by Equation (4):

$${Z}_{r} = \frac{{ω}^{2} {M}^{2}}{{Z}_{s}} = \frac{{ω}^{2} {k}^{2} {L}_{p} {L}_{s}}{{Z}_{s}} = {R}_{r} - {jX}_{r} \qquad ( 4 )$$

where, M=k\sqrt{LₚLₛ} is the mutual inductance between the power coils. From Equations (3) and (4), the real and imaginary parts of Zᵣ can be written as Equations (5) and (6):

$$\begin{matrix}{R}_{r} = \frac{{ω}^{2} {k}^{2} {L}_{p} {L}_{s} ( \frac{1}{{( ω {C}_{p 2} )}^{2} {R}_{eq}} )}{{( \frac{1}{{( ω {C}_{p 2} )}^{2} {R}_{eq}} )}^{2} + {( ω {L}_{s} - \frac{1}{ω {C}_{s 2}} - \frac{1}{ω {C}_{p 2}} )}^{2}} & ( 5 ) \\ {X}_{r} = \frac{{ω}^{2} {k}^{2} {L}_{p} {L}_{s} ( ω {L}_{s} - \frac{1}{( ω {C}_{s 2} )} - \frac{1}{ω {C}_{p 2}} )}{{( \frac{1}{{( ω {C}_{p 2} )}^{2} {R}_{eq}} )}^{2} + {( ω {L}_{s} - \frac{1}{ω {C}_{s 2}} - \frac{1}{ω {C}_{p 2}} )}^{2}} & ( 6 )\end{matrix}$$

The real and imaginary parts of Equations (5) and (6) then are combined with the transmitter network as shown in Equation (7):

$${Z}_{1} = {R}_{r} + j ( ω {L}_{p} - \frac{1}{ω {C}_{s 1}} - {X}_{r} ) \qquad ( 7 )$$

The voltage across the parallel tuning capacitor of the Tx then is specified in Equation (8):

\vec{Vₚ}=\vec{Iₚ}Zₗ (8)

The current through the power coil in an LCL transmitter is unaffected by the load and power coil's inductance variations as expressed by Equation (9):

$$\vec{{I}_{p}} = - j \frac{{V}_{1. rms}}{ω {L}_{t 1}} \qquad ( 9 )$$

The RMS value of the output voltage of the inverter is calculated in Equation (10):

$${V}_{1. rms} = \frac{4 {V}_{in}}{π \sqrt{2}} sin ( π {D}_{p} ) \qquad ( 10 )$$

From Equations (9) and (10):

$$\vec{{I}_{p}} = - j \frac{4 {V}_{i n}}{π \sqrt{2} ( ω {L}_{t 1} )} sin ( π {D}_{p} ) \qquad ( 11 )$$

where, Vᵢₙ is the input DC voltage to the inverter, and Dₚ is the duty cycle of the inverter.

Substituting (7) and (11) into (8), the real and imaginary parts of Vₚ can be expressed as:

$$\begin{matrix}Re [ {V}_{p} ] = ( ω {L}_{p} - \frac{1}{ω {C}_{s 1}} - {X}_{r} ) \frac{4 {V}_{in}}{π \sqrt{2} ( ω {L}_{t 1} )} sin ( π {D}_{p} ) & ( 12 ) \\ Im [ {V}_{p} ] = - j \frac{4 {V}_{in} {R}_{r}}{π \sqrt{2} ( ω {L}_{t 1} )} sin ( π {D}_{p} ) & ( 13 )\end{matrix}$$

The total active power that the transmitter can transfer to the receiver (transmitter power transfer capacity) then is:

$${P}_{in . Rx} = \vert {I}_{p} \cdot Im [ {V}_{p} ] \vert = \vert [ - j \frac{4 {V}_{in}}{π \sqrt{2} ( ω {L}_{t 1} )} sin ( π {D}_{p} ) ] \cdot Im [ {V}_{p} ] \vert \qquad ( 14 )$$

The reflected load and transferred power to the receiver can be obtained from the imaginary part of Vₚ as stated in (13). The power of (14) can then be compared to a reference power for regulation. Moreover, for the LCL-LCL topology there is no need for any transmitter current measurements as a feedback for power control which requires bulky and expensive current transformers. Instead, all the information is calculated from the voltage across the parallel tuning capacitor on the transmitter side.

For other transmitter topologies, the equation for total active power that the transmitter potentially can transfer to the receiver would be different. For instance, for a series-tuned or parallel tuned inverter topologies it can be written as:

$${R}_{r} = \frac{\frac{{V}_{1 , rms}^{3}}{Re [ {I}_{p} ]}}{1 + {( \frac{Im [ {I}_{p} ] \cdot {V}_{1. rms}}{Re [ {I}_{p} ]} )}^{2}} \qquad ( 15 )$$

And therefore:

$${P}_{in . Rx} = {\vert {I}_{p} \vert}^{2} \cdot {R}_{r} = {\vert {I}_{p} \vert}^{2} \cdot \frac{\frac{{V}_{1. rms}^{3}}{Re [ {I}_{p} ]}}{1 + {( \frac{Im [ {I}_{p} ] \cdot {V}_{1. rms}}{Re [ {I}_{p} ]} )}^{2}} \qquad ( 16 )$$

The new current value I_{p.new} can be calculated as shown in FIG. 4. If the estimated tank power P_{in.Rx} is higher that the desired level (Pₒ+P_{loss.Rx}), the supplied power by the transmitter should be decreased to avoid excessive power to be supplied. The new value of Iₚ can then be calculated from Equation (17):

$${I}_{p . new} = {I}_{p} \sqrt{\frac{( {P}_{o} + {P}_{loss . Rx} )}{{P}_{in . Rx}}} \qquad ( 17 )$$

If the estimated tank power P_{in.Rx} is lower that the desired level (Pₒ+P_{loss.Rx}), the new value of Iₚ can then be calculated from Equation (18):

$${I}_{p . new} = {I}_{p} \sqrt{\frac{{P}_{in . Rx}}{( {P}_{o} + {P}_{loss . Rx} )}} \qquad ( 18 )$$

While the current Iₚ is expressed above as be variable based on the duty cycle, in fact there are a number of control variables, or control strategies for the inverter to control the current. Apart from duty cycle control, there is also amplitude control, frequency control and phase shift control.

Because the level of coupling can vary considerably, it is desirable for the control variable to have good dynamic range. For an LCL to LCL topology with a consumer charging mat, coupling may vary between 0.2-0.6.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transmitter comprising:
a power transfer circuit which includes a transmitter coil;
a power inverter including a plurality of control devices configured to drive the power transfer circuit; and
a controller configured to provide drive signals for the control devices,
wherein the controller is programmed to:
estimate the power in the power transfer circuit;
compare the estimated power to a predetermined power level; and
calculate an adjustment to the drive signals based on the comparison, to adjust the power in the power transfer circuit to the predetermined power level.

2. The transmitter according to claim 1, wherein estimated power is an estimate of the real power in the power transfer circuit.

3. The transmitter according to claim 1, wherein predetermined power level includes the rated output power of a receiver together with an estimate of a power loss.

4. The transmitter according to claim 1 wherein the power transfer circuit is selected from the group consisting of
a LCL circuit,
a parallel tuned circuit,
a series tuned circuit,
a non resonant circuit.

5. The transmitter according to claim 4 wherein the power transfer circuit is a LCL circuit, and the estimated power is based on the current through the transmitter coil and the imaginary component of the voltage across a parallel tuning capacitor.

6. The transmitter according to claim 5 wherein the power estimate is based on the formula P_{in.Rx}=|Iₚ·Im[Vₚ]|.

7. The transmitter according to claim 6 wherein the current through the transmitter coil is determined based on the formula
$$\vec{{I}_{p}} = - j \frac{4 {V}_{in}}{π \sqrt{2} ( ω {L}_{t 1} )} sin ( π {D}_{p} ) .$$

8. The transmitter according to claim 1 wherein the power transfer circuit is a series tuned circuit or a parallel tuned circuit, and the power estimate is based on current through the transmitter coil, the real component of the current through the transmitter coil, the imaginary component of the current through the transmitter coil and the RMS output voltage of the transmitter drive circuit.

9. The transmitter according to claim 8 wherein the power estimate is based on the formula
$${P}_{in . Rx} = {\vert {I}_{p} \vert}^{2} \cdot {R}_{r} = {\vert {I}_{p} \vert}^{2} \cdot \frac{\frac{{V}_{1. rms}^{3}}{Re [ {I}_{p} ]}}{1 + {( \frac{Im [ {I}_{p} ] \cdot {V}_{1. rms}}{Re [ {I}_{p} ]} )}^{2}} .$$

10. The transmitter according to claim 1 wherein the power transfer circuit is a non-resonant circuit, the power estimate is based on the current through the transmitter coil and the RMS output voltage of the transmitter drive circuit.

11. The transmitter according to claim 1 wherein the current through the power transfer coil is controlled according to a methodology selected from the group consisting of
amplitude control,
duty cycle control,
frequency control, and
phase shift control.

12. The transmitter according to claim 1 wherein the current through the transmitter coil is decreased if the estimated power is more than the predetermined power level.

13. The transmitter according to claim 12, wherein the current through the transmitter coil is calculated according to the formula
$${I}_{p . new} = {I}_{p} \sqrt{\frac{( {P}_{o} + {P}_{loss . Rx} )}{{P}_{in . Rx}}} .$$

14. The transmitter according to claim 1 wherein the current through the transmitter coil is increased if the estimated power is less than the predetermined power level.

15. The transmitter according to claim 14, wherein the current through the transmitter coil is calculated according to the formula
$${I}_{p . new} = {I}_{p} \sqrt{\frac{{P}_{in . Rx}}{( {P}_{o} + {P}_{loss . Rx} )}} .$$

16. The transmitter according to claim 3, wherein the estimated loss is: a proportion of the rated output power of a receiver, approximately 10 W, or approximately 5 W.

17. The transmitter according to claim 1 wherein the controller determines there is a partial load present if the estimated power is below a threshold and adjusts the predetermined power level.
